(19) United States
(12) Patent Application Publication
(10) Pub. No.: US 2010/0185625 A1
(43) Pub. Date: Jul. 22, 2010

(54) System and Method for Evaluating/Determining Relationship Compatibility Among Members of a Social Network, and for Referring Compatible Members to Each Other

(76) Inventors: Bryce Allan Johnson, San Diego, CA (US); Ralph Joseph Riehl, San Diego, CA (US)

Correspondence Address: Bryce Johnson, 2295 River Run Dr. #9202, San Diego, CA, 92108, US

(21) Appl. No.: 12/555,330

(22) Filed: Sep. 8, 2009

Related U.S. Application Data
(60) Provisional application No. 61/094,905, filed on Sep. 6, 2008.

(51) Int. Cl. G06F 17/30

(52) U.S. Cl. 707/748; 707/E17.044

(57) ABSTRACT

Disclosed, among other things, is a method for evaluating/determining relationship compatibility among a pool of individuals and for referring compatible members to each other for dating and/or other types of relationships.

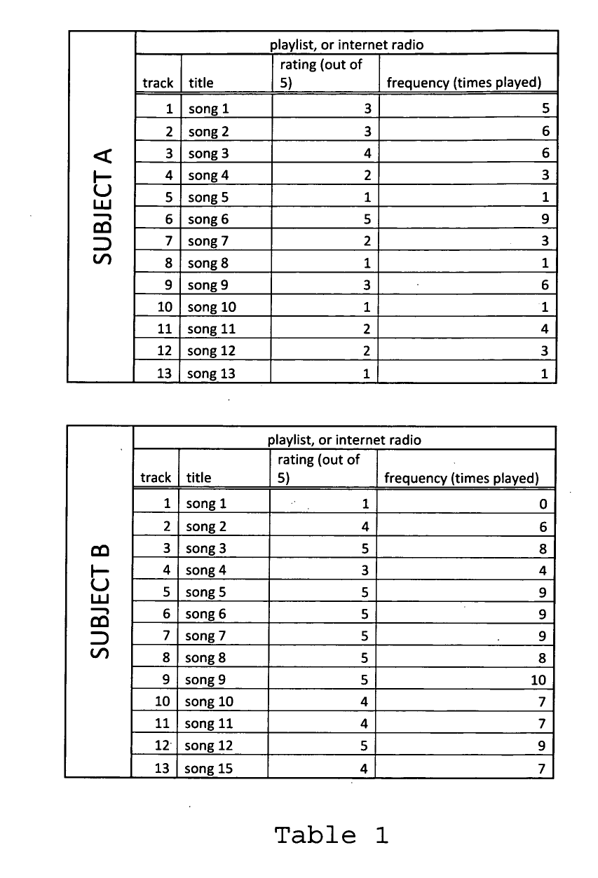

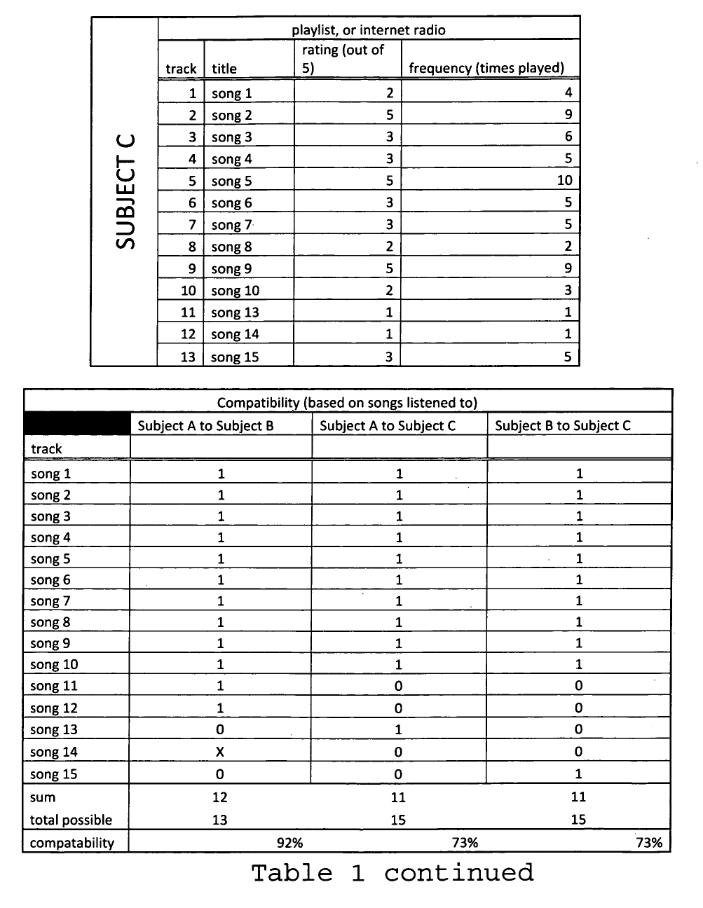

### CROSS-REFERENCE TO RELATED APPLICATIONS

This application claims the priority of the U.S. provisional patent application Ser. No. 61/094,905 filed on Sep. 6, 2008 and entitled “System and Method for Evaluating/Determining Relationship Compatibility Among Members of a Social Network, and for Referring Compatable Members to Each Other.”

### STATEMENT REGARDING FEDERALLY SPONSORED RESEARCH OR DEVELOPMENT

Not applicable.

### BACKGROUND OF THE INVENTION

1. Field of Invention

The following application is in the field of methods for evaluating/determining relationship compatibility among members of a social network and for referring compatible members to each other for dating and/or other types of relationships. Moreover, the following is in the field of methods for the determining whom among a social network is compatible with whom and referring compatibles to each other for dating and/or other types of relationships. Yet still, the following is in the field of social matchmaking within a pool of individuals and referring match-made parties to each other or facilitating match-made party acquaintance. Even still, the following is in the field of social matchmaking within a pool of individuals, wherein compatibility is computed in real-time, and wherein individuals are referred to all compatibles within said pool of individuals for dating and/or other types of relationships. Finally, the following is in the field of dating and/or matchmaking services.

2. Background of the Invention

In general, social networks, especially on-line, are a pool of individuals who each create a member profile which states information regarding the particular individual. Such information typically consists of the profile creator's unilateral statements of geographic location, educational and work related activities, yearly salary, physical description, interests, hobbies, zodiac sign, musical preferences, relationship status, favorites, and desirable individuals such as celebrities or political figures. Relationships within the social network are either pre-existing or initiated by members after an examination of another's profile provokes interest.

Sometimes, dating or matchmaking services are provided to members of a social network. Typically, compatibility among members, especially regarding intimate relationships such as dating, is evaluated/determined by matching member personalities as determined via an initial personality test or questionnaire and member information as unilaterally stated in the member's profile. Compatible members, according to the above criteria, are referred to each other.

There are many problems associated with social networks and the associated dating or matchmaking services, as pertaining to evaluating/determining compatibility. First, member profiles are unilateral and unverified statements taken as true by viewing members of the social network or the matchmaking services. Second, member profiles are not automatically updated resulting in the information contained therein being stale for some duration. Third, personality changes from day-to-day and over time, which is not accurately reflected by an initial personality test or even periodic personality tests. These problems, among others, result in flawed determinations of compatibility and result in unfortunate referrals.

Also, generally social networks or dating services charge a membership fee whereby services are paid thereby. Often, these fees are in the form of a monthly installment, which can aggregate to a large cost for the members.

### SUMMARY OF THE INVENTION

Accordingly, it is an object of the present invention to provide a method for evaluating/determining relationship compatibility among members of a social network and for referring compatibles to each other for dating and/or other types of relationships, which relies primarily on circumstantial and objective manifestations of lifestyle, interest, character, or personality rather than exclusively on unilateral statements or one-time personality tests.

It is another object of the present invention to provide a method for evaluating/determining relationship compatibility among members of a social network and for referring compatibles to each other for dating and/or other types of relationships, which evaluates/determines compatibility in almost real-time.

It is yet another object of the present invention to provide a method for evaluating/determining relationship compatibility among members of a social network and for referring compatibles to each other for dating and/or other types of relationships, which provides other means for financing in addition monthly fees for members whereby the monthly fees are reduced.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

Table 1 is a crude example of how to compare logs of impromptu and/or otherwise unrehearsed objective and circumstantial manifestations of lifestyle, interest, character, or personality of members of a social network or other pool of individuals.

### DETAILED DESCRIPTION OF PREFERRED METHODS

Generally, the method of the present application involves: logging the impromptu and/or otherwise unrehearsed objective and circumstantial manifestations of lifestyle, interest, character, or personality of members of a social network or other pool of individuals (i.e., manifestations which are not stated, made or prepared for the sole purpose of stating one's own lifestyle, interest, character, or personality, or i.e., facts of independent significance other than to specifically communicate one's own lifestyle, interest, character, or personality to others); collecting and transmitting the logs to a central server or databases; comparing transmitted member logs for commonalities; matching logs with a threshold level of commonality; and, referring the members with matched logs to each other for a date or relationship, or expressing the level of commonality between the members' logs with a suggestion that members above a threshold level of commonality meet for a relationship or a date. An optional step in the method is to advertise with (or sponsor) each referral, the products, media, and etcetera, which frequently occur (or are present frequently) in the matched log, or are analogous to items which frequently occur in the logs. This process repeats periodically, systematically, or scheduledly whereby the logs and/or databases are constantly updating. The method can be best illustrated by way of example:

### EXAMPLE

Subject A, along with all members of a social network, have each individually and actually collected, listened, viewed, played, downloaded or otherwise acquired or used or enjoyed a variety of music, movies, television shows, videogames, magazines, or other media. The items within subject A's and each social network member's media library and or media history, and optionally the acquisition/view date and itemized frequency of individual media use and the owner's evaluation of the item, are logged. Subject A's itemized log is compared to the log of every other member of the social network for commonalities, giving weight to acquisition date, frequency and evaluation (if available). If subject A's log is sufficiently common with the log of another member, subject A is referred to that member for a relationship, along with any other member of the social network who's logs are sufficiently common. So too are the other member's who's logs match, referred to one another whereby each member of the social network develops a referral or date list. As subject A's and other members' media library and or media history, and optionally the acquisition/view date and itemized frequency of individual media use and the owner's evaluation of the item, expands or recedes, the referral or dating lists change to reflect the acquisition or recession. Furthermore, the social network referral service provider (and/or dating/matchmaking service provider) could use the member's logs for customized advertising whereby the costs of the referral services are transferred to advertisers instead of the members.

### EXAMPLE

Subject A and other members of a social network, each download video clips off internet sites (such as youtube or metacafe). The download/viewing history of each subject is logged, normally including the date and/or frequency of download. Subject A's historical log is compared for commonalities to others' log within the social network. If subject A's log is sufficiently common with the log of another member, subject A is referred, for a relationship and/or date, to that member, along with any other member of the social network who's logs are sufficiently common. So too are the other member's, who's logs sufficiently match, referred to one another whereby each member of the social network develops a referral or date list. As subject A's and other members' download/viewing/playing/listening history grows, the referral or dating lists change to reflect the newer historical data. Furthermore, the social network referral service provide (and/or dating/matchmaking service provider) could use the member's logs for customized advertising whereby the costs of the referral services are transferred to advertisers instead of the members.

### EXAMPLE

Subject A uses a cell phone (for example the Apple I-phone) or PDA or any other communication means including a computer (hereinafter “device”), with internet access, media storage capacity, and a variety of software applications, viewing screen (visual output), sound output capability, and optionally wireless or wired communication capability. Subject A, a member of a social network wherein all other members use similar devices, has a software installed on his device which tracks and/or logs subject A's use of his device, for instance by: logging the song titles or playlists of music, videos, games, or other media which Subject A has used, played, listened, viewed, downloaded, deleted, or otherwise implemented or evaluated, on his device; logging application and/or software name and uses (including logging the frequency and optionally the user evaluation thereof) installed on the device; logging internet sites visited by subject A on his device (which may include the browsing history including frequency of visits and dates); logging the playlists or downloaded media on device; logging radio stations listened to on his device (and including song skips or frequency of song listened and optionally the evaluation of the songs listened to); logging blogs visited, and magazines or news read on the device; logging TV shows, videos, video clips (from sites such as youtube or other video portals), or movies recently viewed on the device; logging video games played on the device; logging what programs were downloaded or installed on the device; logging search terms employed on internet search engines, while surfing the net on the device; logging what clothing stores were visited online and type/brand of clothing purchased on-line using the phone, or any other type of purchase history; logging phone numbers or other device numbers of restaurants or other stores called using the phone; logging purchases made using the device; and, using the device to log media stored on DVR, TIVO or the like (including apple TV). If subject A's log is sufficiently common with the log of another member, subject A is referred, for a relationship and/or date, to that member, along with any other member of the social network who's logs are sufficiently common. So too are the other member's, who's logs sufficiently match, referred to one another whereby each member of the social network develops a referral or date list. As subject A's and other members' download/viewing/playing/listening history grows or otherwise changes (including via deletion), the referral or dating lists change to reflect the newer historical/updated data. Furthermore, the social network referral service provider (and/or dating/matchmaking service provider) could use the member's logs for customized advertising whereby the costs of the referral services are transferred to advertisers instead of the members.

### EXAMPLE

Subject A has a movie/video game rental account (whether online or otherwise) (for instance blockbuster or netflix). Subject A is a member of a social network individuals, wherein the other members of the social network also maintain a movie rental account. Subject A's and the other members of the social network's rental history is logged, including date of rental, and the logs compared for commonalities. If subject A's log is sufficiently common with the log of another member, subject A is referred, for a relationship and/or date, to that member, along with any other member of the social network who's logs are sufficiently common. So too are the other member's, who's logs sufficiently match, referred to one another whereby each member of the social network develops a referral or date list. As subject A's and other members' rental history grows, the referral or dating lists of the individual members change to reflect the newer historical data and new commonalities. Furthermore, the social network referral service provider (and/or dating/matchmaking service provider) could use the member's logs for customized advertising whereby the costs of the referral services are transferred to advertisers instead of the members.

### EXAMPLE

Subject A and other members of a social network, each of which surf internet sites and respond to advertisements or links by mouse (or otherwise) clicking thereon. The click history of each subject is logged, normally including the date and/or frequency of each click (i.e., which ads or links the subjects are clicking on). Subject A's historical click log is compared for commonalities to others' log within the social network. If subject A's log is sufficiently common with the log of another member, subject A is referred, for a relationship and/or date, to that member, along with any other member of the social network who's logs are sufficiently common. So too are the other member's, who's logs sufficiently match, referred to one another whereby each member of the social network develops a referral or date list. As subject A's and other members' download/viewing/playing/listening history grows, the referral or dating lists change to reflect the newer historical data. Furthermore, the social network referral service provide (and/or dating/matchmaking service provider) could use the member's logs for customized advertising whereby the costs of the referral services are transferred to advertisers instead of the members.

It should be understood that the aforementioned examples are in no way limiting of the types of impromptu and/or otherwise unrehearsed objective and circumstantial manifestations of lifestyle, interest, character, or personality which may be logged.

The manner in which impromptu and/or otherwise unrehearsed objective and circumstantial manifestations of lifestyle, interest, character, or personality may be logged and matched is via collection and transmission to a storage in relational database, whether on-line or otherwise. Ideally data regarding the aforementioned manifestations would be collected uninterruptedly and backgroundedly as the members of the social network conducts activities, especially while using an electronic or communicative/communication device wherein said manifestations are inherently logged by installed computer software, driver, operating system, hardware or otherwise. For instance, in any of the examples stated above, the internet browsing history, download history, viewing history, media play history, stored playlist, electronically stored media, radio stations listened to along with music skipped or rated, purchase history, video rental history, video game play history, and etcetera (including frequency of use, date and time, and the member's evaluation of each item if available) is usually collected or inherently identifiable in the software or driver utility which runs/plays such applications or media. Similarly, more and more credit card statements are being itemized according to purchase and/or store where the card was used. Accordingly, such items could be backgroundly collected and delivered to an online database via software designed for such purposes (of course privacy would be paramount and accounted for). Also, software could be implemented which runs simultaneously and uninterruptedly with other applications or drivers on the electronic or communication device whereby the activity of the device user is backgroundly and uninterruptedly collected and transmitted to a data base, relational database, or any other type of data storage. The development of such software is readily straight forward, and will be known by one skilled in the pertinent art. Furthermore, software already exists which compiles such data (or which compilation is a side effect of the operating software or driver), and accordingly, a software could be developed which simply piggybacks on the preexisting software or applications on a device.

Once compiled and/or during compilation within the database, the data could be organized per member of the social network and each member's data compared and matched via visual inspection the logs or by database computer language designed for the retrieval and management of data in relational database management systems, database schema creation and modification, and database object access control management. For example SQL, which is a standard interactive and programming language for querying and modifying data and managing databases, could be employed. The core of relational database management is forming command language that allows the retrieval, comparison, insertion, updating, and deletion of data, and performing management and administrative functions. SQL also includes a Call Level Interface (SQL/CLI) for accessing and managing data and databases remotely. Such use of database computer language will be readily apparent and known to one skilled in the art.

Table 1 is a crude illustration for computing the compatibility between members of a social network comprising subject A, subject B, and subject C. In the present illustration, the impromptu manifestation of personality and or lifestyle, and or etcetera which was logged and transmitted to a database, is a music playlist or internet radio song history. For simplification, the compatability computation will involve only the specific songs actually listened, even though the listener rating of the song and the frequency listened to for each song were logged and transmitted too. A more complex illustration would involve weighting each log using the user evaluation/rating and frequency of listening to a particular song. Once the logs have been transmitted to a central database, the logs are compared for commonalities. Overall commonality can be computed based on the total number of items or the total number of potential matches in the respective logs. The results of commonality comparison are given in the table. The members of a social network are referred to each other for a relationship or date depending on whether the logs are sufficiently common or meet a threshold level of commonality. The threshold level may be predetermined by the dating and or relationship referral service or by the individual members of the social network. Generally, matching will be more effective if the commonality rate for a given set of logs is at least 50%. Subject thereto, members may be informed of the commonality rate regardless of the actual rate (in other words, a member may be referred to another member of the social network with a qualification that the referral was below 50% or did not meet the threshold level.

I claim:

1. A method of matchmaking using at least one device comprising the steps of:
backgroundedly logging at least one impromptu and/or otherwise unrehearsed objective and circumstantial manifestation of lifestyle, interest, character, or personality of a first individual via a first device;
backgroundedly logging at least one impromptu and/or otherwise unrehearsed objective and circumstantial manifestation of lifestyle, interest, character, or personality of a second individual via a second device; and,
determining the level of commonality between the resultant first and second logs.
